(19) United States
(12) Patent Application Publication
(10) Pub. No.: US 2005/0173875 A1
(43) Pub. Date: Aug. 11, 2005

(54) Collapsible transport vehicle

(76) Inventor: Reinhard Stedry, Kempen (DE)

Correspondence Address: CANTOR COLBURN, LLP, 55 GRIFFIN ROAD SOUTH, BLOOMFIELD, CT, 06002, US

(21) Appl. No.: 10/502,429

(22) PCT Filed: Jan. 24, 2003
(86) PCT No.: PCT/EP03/00748

(30) Foreign Application Priority Data
Jan. 24, 2002 (DE) 202 00 989.0

(51) Int. Cl. B62B 3/02

(52) U.S. Cl. 280/30

(57) ABSTRACT

The invention related to a collapsible transport vehicle comprising a load-receiving surface and at least one pair of running wheels. In order to create a transport vehicle that can be assembled and collapsed in a simple manner requiring only a few manipulations and that has a relatively small size in a collapsed position, the running wheels are arranged on wheel suspensions which are pivotally connected to one side of the load-receiving surface, and the load-receiving surface is provided with at least one joint, by which the load receiving surface is collapsed.

The invention relates to a collapsible transport vehicle with a load-receiving platform and at least one pair of running wheels.

Transport vehicles or transport carts, for example in the form of hand trucks or handcarts, are used for transporting loads. For example, transport vehicles are known which are designed to hold cases of beverages and are used in shopping. Known transport vehicles ordinarily are designed to have two or four wheels.

Also known are transport vehicles that are equipped with a towing attachment and can be attached to a two-wheeled vehicle, for example a bicycle or a moped, and can also be used to transport loads such as cases of beverages, luggage, or the like.

When transport vehicles of this type are not in use, they require a relatively large amount of space for storage due to their dimensions. For this reason, collapsible transport vehicles have already been proposed, which when not in use can be collapsed to a size that is smaller than their assembled size. When collapsed, transport vehicles of this type require less storage space, and they can be transported more easily when not in use.

The problem with known collapsible transport vehicles, however, is that they frequently are equipped with running wheels that are relatively small in diameter, which results in unfavorable driving properties. Furthermore, known collapsible transport vehicles frequently are still substantial in size even when collapsed.

It is thus the object of the invention to disclose a collapsible transport vehicle of the type initially specified that can be easily set up and collapsed in just a few steps, and that in the collapsed state is relatively small.

In attaining this object, the invention proposes that in a collapsible transport vehicle of the type initially specified, the running wheels be arranged on wheel suspensions that are pivotably mounted on one side of the load-receiving platform, and that the load-receiving platform be equipped with at least one joint, via which the device can be collapsed.

The combination of wheel suspensions that are pivotably attached to the load-receiving platform and a joint that is incorporated in the load-receiving platform, for example a hinged joint, allows highly compact collapsing of the transport vehicle when it is not in use. When the transport vehicle is not needed, the wheel suspensions are pivoted toward the load-receiving platform, with or without the running wheels attached, and the load-receiving platform is folded down along the at least one joint. The at least one joint on the load-receiving platform is preferably arranged such that the size of the load-receiving platform is reduced approximately by one-half when collapsed.

In this design the running wheels can be detachably connected to the wheel suspensions via pivots and securing devices, and can be separated from these in order to collapse the transport vehicle; preferably, however, the running wheels are rotatably attached to the wheel suspensions and remain installed on the wheel suspensions even when the transport vehicle is collapsed. The running wheels can be made of any suitable material, resins, foams, foamed resins, solid rubber, or the like. The running wheels may also be designed as pneumatic tires, which, depending upon their construction, may also be designed to be tubeless.

In order to stabilize the chassis of the transport vehicle with the wheel suspensions and the running wheels when the transport vehicle is in its assembled state, according to a further development of the invention it is proposed that the wheel suspensions of the at least one pair of running wheels be located opposite one another when the transport vehicle is in its assembled state, and that they be stabilized against one another by means of a cross-strut that extends between the wheel suspensions.

In setting up the transport vehicle specified in the invention, once the load-receiving platform has been opened up and the wheel suspensions have been pivoted, the stabilizing cross-strut is positioned between the wheel suspensions, and each end of the cross-strut is attached to a wheel suspension.

In order to facilitate the set-up of the transport vehicle and to keep the transport vehicle from comprising a multitude of individual components in the collapsed state, it is proposed that the cross-strut be pivotably attached to the load-receiving platform, on the side of the platform that faces the wheel suspensions when it is folded down, such that the cross-strut can be shifted from a position of rest, in which it extends essentially parallel to the wheel suspensions, into an operating position, in which it connects the wheel suspensions, supporting them against one another.

With this design for the transport vehicle, the cross-strut, which is installed for the purpose of stabilizing the wheel suspensions when the transport vehicle is set up, is attached captively to the load-receiving platform. To collapse the transport vehicle, the cross-strut is detached from the wheel suspensions and pivoted or rotated, preferably in a direction that is parallel to the joint in the load-receiving platform, the wheel suspensions are pivoted, and the load-receiving platform is collapsed. To set up the transport vehicle this process is reversed, the load-receiving platform is unfolded, the wheel suspensions are pivoted outward and the cross-strut is pivoted and attached to the wheel suspensions.

Particularly simple handling of the cross-strut in the set-up and collapse of the transport vehicle results when, as provided according to a further modification of the invention, locking mechanisms are positioned on the wheel suspensions, which operate in conjunction with the ends of the cross-strut to lock the cross-strut to the wheel suspensions in the operating position. With locking mechanisms of this type, the cross-strut can be connected to and locked with the wheel suspensions by means of a simple step, and can be detached again by actuating an unlocking mechanism.

According to a further modification of the invention it is provided that the load-receiving platform in the unfolded state is equipped on its side facing the wheel suspensions with a bar that extends between the wheel suspensions and parallel to them, to which the cross-strut is mounted such that it can pivot. In this embodiment, the cross-strut extends between the wheel suspensions, spaced somewhat from the base of the load-receiving platform, whereby the mutual support of the wheel suspensions and thereby the stabilization of the entire chassis is improved. Advantageously, the ends of the cross-strut engage the wheel suspensions approximately at the points at which the running wheels are rotatably connected to the wheel suspensions.

For further stabilization of the chassis of the transport vehicle it is advantageous if, as provided in a further modification of the invention, the transport vehicle is equipped with support struts that are connected in an articulated fashion to the wheel suspensions on one side and to the load-receiving platform on the other side, and that extend diagonally when the transport vehicle is set up, wherein each support strut is equipped with a joint, located between the point of connection with the load-receiving platform and the point of connection with the wheel suspension, so that when the wheel suspensions are being pivoted from an operating position to a position of rest, the support struts can be collapsed. Preferably, the support struts are each prestressed by means of a return spring, which can be designed, for example, as a coil spring. The advantage of this embodiment is that the transport vehicle can be easily collapsed because the support struts are automatically shifted to their collapsed position by the force of the return springs.

To extend the support struts a cable control to be actuated by the operator is provided, via which the support struts can be unfolded against the force of the return springs. To operate this cable control an actuating mechanism that is easily accessible to the operator can be provided, which can be actuated, for example, by means of a simple operation. As an alternative to the embodiment comprising a cable control, it is also possible to unfold the support struts by means of hydraulic or pneumatic power. It is critical only that the operator of the transport vehicle be able to generate the unfolding force required to open up the support struts easily and comfortably and to transfer this force to the support struts as desired. This can be accomplished by means of a shaft assembly, via the described cable control embodiment, or even hydraulically or pneumatically.

The support struts offer additional stabilization against transverse loads. Because the support struts are equipped with joints, when the wheel suspensions are being pivoted they can be folded together along with them, without the support struts having to be separated from the wheel suspensions and/or from the load-receiving platform.

According to a further modification of the invention, the transport vehicle is equipped with a drawbar arranged on the load-receiving platform. With the help of the drawbar the transport vehicle can be pulled or pushed by hand, however the drawbar may also be used to attach the transport vehicle to a towing vehicle, for example a two-wheeled vehicle. Preferably, however, the drawbar is fastened to a bar located underneath the load-receiving platform, in order to generate better leverage. The drawbar is positioned such that it can pivot relative to the bar and can, if necessary, be locked onto the bar or the load-receiving platform in a given position.

In order to ensure the collapsibility of the transport vehicle to compact dimensions it is provided, according to a further development of the invention, that the drawbar is arranged on the load-receiving platform such that it can pivot. According to a further modification of the invention, the transport vehicle is equipped with a device for securing the drawbar in its operating position.

With this type of locking device the drawbar is prevented from pivoting when the transport vehicle is being pulled or pushed along. In this way the transport vehicle can be safely operated. As the locking device, the hauling device can be equipped, for example, with openings in the drawbar and in the load-receiving platform, and with a locking pin that can be inserted into these openings to secure the drawbar in its operating position. This locking pin is removed prior to collapsing the transport vehicle and can then be used advantageously to fasten the elements of the transport vehicle in their collapsed state, in order to prevent individual components of the transport vehicle from unintentionally opening up.

According to a further advantageous modification of the invention, a handle is positioned on the drawbar. This handle can be used to pull or push the transport vehicle by hand.

Advantageously, according to a further modification of the invention, the vehicle can be equipped with a locking device that can be actuated via the handle. By actuating the locking device the transport vehicle can be secured in a parked position against unintentionally rolling away.

In the design of the locking device, according to a further modification of the invention, the transport vehicle can be equipped with a shaft that extends along the drawbar and is connected to the handle, and which operates in conjunction with an arrangement comprised of at least one gear and possibly additional shafts with two shafts that are provided with cams and, when the transport vehicle is set up, are located above the wheels, such that when the transport vehicle is set up and the shaft that extends along the drawbar is rotated, the cams of the two shafts act upon brake pads located above the running wheels, which then prevent the running wheels from rotating. In this type of design the brake pads are floating. When the handle is actuated, i.e. rotated, the shaft that extends along the drawbar is rotated and effects, via the arrangement that is comprised of at least one gear and if necessary additional shafts, a rotation of the shafts positioned above the running wheels, wherein the cams press the brake pads in the direction of the running wheels. In this position the brake pad acts against the running wheels and prevents the running wheels from rotating, thereby preventing the transport vehicle from rolling away.

Alternatively it can also be provided that the brake pad can be actuated by means of a cable control. This would then be connected to the brake pad in a known manner and fed via the drawbar up to the handle. To actuate the cable control, a corresponding device is arranged on the handle, which can be easily actuated by the operator or user of the transport vehicle. For this purpose the handle may be either movable or rigid in design, wherein if the handle is rigid a corresponding actuating mechanism for the actuation of the cable control must be provided. Such an actuating mechanism can, for example, be designed in the form of a lever that is connected in an articulated fashion to the handle, which when needed is grasped by the user and articulated to actuate it. This articulation causes the cable control to be stretched, pressing the brake pad against the running wheels. Alternatively to the embodiment of a brake pad, an arrangement comprising brake shoes or drum brakes may also be provided.

Especially in the case of a two-wheeled transport vehicle, it is advantageous if, in accordance with a further modification of the invention, supports are provided on the two shafts that are equipped with cams, which, when these shafts are rotated into the position in which the cams act upon the brake-pads, are unfolded to support the transport vehicle, while when the two shafts are in a normal position, in which the cams are not acting on the brake pads, rest folded down underneath the load-receiving platform. The supports, which unfold when the handle is rotated and thereby the shafts arranged above the running wheels are rotated, prevent the two-wheeled transport vehicle from tipping over, and cause the load-receiving platform to rest essentially horizontally. Because the extension of the supports is connected with the actuation of the brake pads, the supports are protected against damage caused by any unintentional movement of the cart. When the supports are extended, the cart is prevented from moving by the action of the brake pads.

The transport vehicle is preferably equipped with a total of four supports, with each corner of the transport vehicle being equipped with one support. Alternatively, one or two supports may be provided optionally only at the front, or one support may be provided in the front and one in the back. What is critical, however, is that with this supplementary arrangement of supports, supporting of the transport vehicle when it is set up can be achieved. This type of support is advantageous not only from the standpoint of safety, it also ensures easy loading and unloading of the transport vehicle. Each of the supports is equipped at its end facing the transport vehicle with a folding mechanism that allows the supports to be folded down to save space when not in use. Such a folding down of the supports can alternatively be effected by means of a cable control, with such a cable control being actuated via a lever mechanism located on the handle or some similar mechanism. In this case, in contrast to the previously described exemplary embodiment, the handle that is provided at the end of the drawbar is designed to be rigid and is equipped with a lever mechanism, via which the supports can be unfolded.

In order to be able to fold the transport vehicle down to the most compact size possible, it is advantageous for the drawbar to be equipped with at least one joint, according to a further modification of the invention. If the transport vehicle has a shaft that extends along the drawbar, this shaft can be provided with a universal joint at the point at which the drawbar is equipped with the joint.

To better secure and fasten the items to be hauled on the load-receiving platform, the load-receiving platform is equipped on the edges of the sides that are opposite the wheel suspensions with boundary panels, according to a further modification of the invention. In setting up the transport vehicle these boundary panels can be folded out, creating surrounding edges for the load-receiving platform. When collapsing the transport vehicle, the boundary panels are folded down in order to decrease the size of the folded-up transport vehicle.

Advantageously, according to a further modification of the invention, the transport vehicle can be folded down to the size of a suitcase by pivoting the wheel suspensions, folding the load-receiving surface together, and folding down the drawbar. In addition, a carrying handle can advantageously be positioned on one of the elements of the transport vehicle, which can then be used when the cart is collapsed. A transport vehicle of this type can be hauled and stored like a regular suitcase when it is collapsed. When the transport vehicle is required for transport, it is set up. Due to the simple design comprising the pivoting wheel suspensions, a collapsible load-receiving platform and the folded-down drawbar, the transport vehicle can converted using simple and convenient steps from its compact suitcase form to its assembled usable form.

According to a further variation, the transport vehicle can be equipped with mounting elements with which it can be fastened in a collapsed state to a bicycle rack.

Finally, according to a further modification of the invention, the transport vehicle is equipped with a mounting assembly positioned on its load-receiving platform, to allow a child safety seat to be attached. In addition, the mounting assembly can be designed to be compatible with a mounting assembly for a child safety seat that can be mounted, for example, on a bicycle rack, so that a child safety seat can be attached optionally as needed either to a bicycle rack or to the load-receiving platform of the transport vehicle of the invention.

Preferably the load-receiving platform, the drawbar, the wheel suspensions, and the struts of the transport vehicle of the invention are made of a lightweight metal, preferably aluminum.

Further advantages and characterizing features of the invention are disclosed in the following description of an exemplary embodiment, with reference to the attached drawings. The drawings show:

FIG. 1 a schematic representation of a transport vehicle pursuant to the invention in its assembled state,

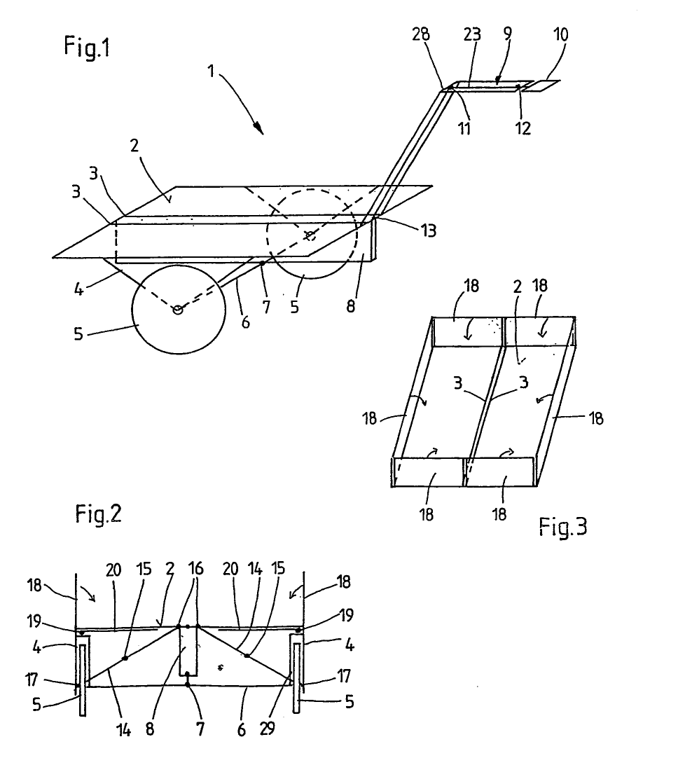

FIG. 2 a schematic representation of a front view of the transport vehicle of the invention in its assembled state, without the drawbar,

FIG. 3 a schematic representation of a plan view of the load-receiving platform of a transport vehicle of the invention, with foldable boundary panels,

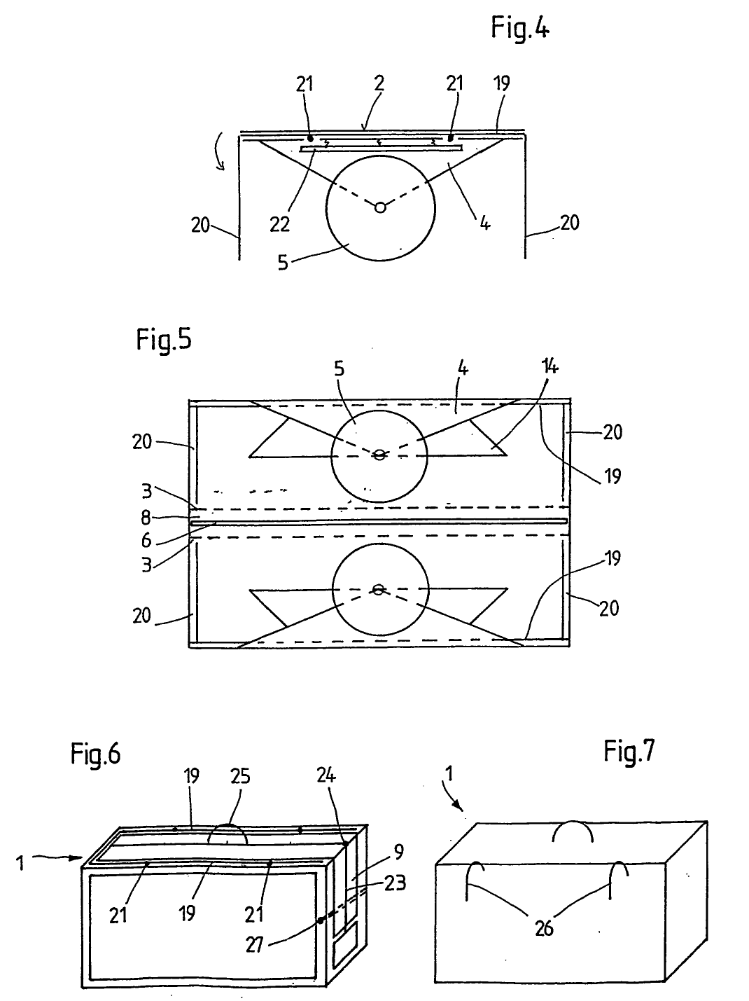

FIG. 4 a schematic representation of a detail of a locking assembly for a running wheel of the transport vehicle of the invention, from a side view,

FIG. 5 the transport vehicle in a partially collapsed state (without drawbar),

FIG. 6 the transport vehicle in a completely collapsed state, and

FIG. 7 the transport vehicle in a completely collapsed state with fastening devices attached thereto, designed for use in fastening the cart to a bicycle rack.

In the drawings a transport vehicle 1 as specified in the invention is schematically and in part sectionally illustrated. The transport vehicle 1 comprises a load-receiving platform 2, which in the present case measures ca. 610×460 mm. On the underside of the load-receiving platform 2 (shown in FIG. 1) wheel suspensions 4 are arranged, on which running wheels 5 are rotatably mounted. Between the wheel suspensions 4 a cross-strut 6 extends (clearly shown in FIG. 2), which is rotatably and/or pivotably connected via a joint 7 to a bar 8, which when the vehicle is set up is located underneath the load-receiving platform 2. Additionally, between the wheel suspensions 4 and the underside of the load-receiving platform 2, support struts extend diagonally when the transport vehicle 1 is set up, each of which is equipped approximately at its center with a joint 15. The load-receiving platform 2 is equipped approximately at its center with two hinged joints 3 located approximately at its center and extending parallel to one another, lengthwise along the assembled transport vehicle 1. As is illustrated especially clearly in FIG. 2, the wheel suspension 4 is supplemented with a rocker 29, so that the wheel 5 is fully guided when installed. Furthermore, the wheel is positioned within the lateral dimensions of the transport vehicle. The rocker 29 can be fully collapsed with the outer element, designated as the wheel suspension 4, and the wheel 5 when the assembly is folded down. The wheel suspension 4, the rocker 29, and the wheel 5 may also be designed as a rigid assembly.

Pivotably attached to the load-receiving platform 2 is a drawbar 9, which is equipped with a joint 28 that allows it to be folded down. A handle 10 is arranged on the drawbar 9.

The handle 10 is connected to a shaft 23 that extends along the drawbar, said shaft being equipped in the area of the joint 28 of the drawbar 9 with a universal joint 11. The drawbar 9 may also comprise additional joints, universal joints, and the like, which will allow it to be collapsed even further or to be used more flexibly. The shaft 23 is arranged in the area of the load-receiving platform 2 on a gear, which is not illustrated here, which transfers rotational movement of the shaft 23, via additional shafts and gear elements, to shafts 19 that extend lengthwise along the assembled vehicle, along the edge of the load-receiving platform 2. On the shafts 19 supports 20 are arranged, which normally rest underneath the load-receiving platform 2 when the transport vehicle 1 is assembled. When the handle 10 on the drawbar 9 is rotated, the shafts 19 are rotated such that the supports 20 extend and, as illustrated in FIG. 4, support the vehicle. At the same time, cams 21 arranged on the shafts 19 act on brake pads 22 that, when the transport vehicle 1 is assembled, are located above the running wheels 5. The brake pads 22 are mounted such that they are floating, and are pressed against the running wheels 5 via the cams 21 thus locking them.

By rotating the handle 10, the transport vehicle 1 can thus be parked safely, with no danger of rolling away and with an essentially horizontal load-receiving platform.

Pursuant to an alternative proposal of the invention, the supports may also be pivotable via a cable control. For this purpose a control cable is provided, extending along the drawbar or through the drawbar, which is then connected to an actuating mechanism positioned on the handle. In contrast to the above-described shaft arrangement, in this alternative embodiment the supports can be folded down by activating the cable control. For this purpose, the actuating mechanism must be operated, so that, in contrast to the above-described exemplary embodiment, the handle can be designed to be rigid and non-rotatable. Actuation of the brake pads may also be implemented via a cable control arrangement. Furthermore, as an alternative to the brake pads, an arrangement comprising brake shoes or a drum brake design is also possible.

If the handle is designed to be rigid, a lever arranged on the handle for the purpose of actuating the supports is preferably provided. This lever is arranged on the handle such that it can pivot, and can be easily grasped and actuated by the operator of the transport vehicle.

To securely support the transport vehicle four supports are preferably provided, each of which is positioned at a corner of the transport vehicle. Alternatively, however, one or more supports may be provided on the front of the transport vehicle, or one support may be provided each at the front and at the rear of the transport vehicle. What is critical, however, is that when the supports are unfolded, secure positioning of the transport vehicle can be ensured.

In FIG. 3 it is schematically illustrated that the load-receiving platform 2 is equipped along its edges with foldable boundary panels 18, which, when folded out, form a side wall surrounding the load-receiving platform 2, thus preventing goods being transported from falling off.

The vehicle shown here, with the exception of the running wheels 5, is made of aluminum, with plastic cap pieces placed on the edges to protect against impact. The running wheels 5 are supported on ball bearings and have a wheel diameter of 300 mm, and the running wheels 5 are fitted with solid rubber tires.

In FIG. 5, the transport vehicle specified in the invention is shown in a partially collapsed state. Here it can be easily recognized that the cross-strut 6 has been pivoted out of its position in an assembled transport vehicle 1, in which it connects the wheel suspensions 4, into a position between the wheel suspensions 4 that extends essentially parallel to the bar 8. When the transport vehicle 1 is set up, the ends of the cross-strut 6 are locked to the wheel suspensions 4 via locking mechanisms, and they are separated from the wheel suspensions 4 to allow the transport vehicle 1 to be folded down. In FIG. 5 it is further apparent that the wheel suspensions 4 are folded over in the direction of the load-receiving platform 2, wherein the cross-struts 14 are folded in at the joint 15 until they come to rest flat against the underside of the load-receiving platform 2. In FIG. 5 the drawbar, which is still folded out, is not shown.

In a subsequent step the transport vehicle 1 is collapsed to the form of a suitcale, as shown in FIG. 6. To accomplish this, the load-receiving platform 2 is folded along the hinged joints 3, and the drawbar 9 is folded down at the pivoted attachment to the load-receiving platform 2 and the joint 28. To secure the transport vehicle 1 in its collapsed form a locking pin 27 is inserted through openings in the load-receiving platform 2 and the drawbar 9, so that the transport vehicle 1 cannot open up unintentionally once it has been collapsed.

The locking pin 27 used to secure the transport vehicle in its collapsed form also serves as a locking pin to fasten the articulated connection between the drawbar 9 and the load-receiving platform 2 when the transport vehicle 1 is set up. To this end, when the transport vehicle 1 is set up the pin is inserted through openings provided in this area into the drawbar 9 and the load-receiving platform 2. Alternatively, in place of the locking pin 27, a clamping fixture may also be provided, which can be easily operated manually by the user.

FIG. 6 further shows that a handle 25 is provided on the drawbar 9, which makes it possible to carry the folded transport vehicle 1 like a suitcase. When it is collapsed, the dimensions of the transport vehicle 1 are ca. 550×350×20 mm, thus it can be conveniently carried along as luggage, including as hand-held luggage on an airplane.

Finally, FIG. 7 illustrates that the transport vehicle 1 is equipped with hanging brackets 26 that allow it to be hung on a bicycle rack in the collapsed state. These brackets 26 are optional and may be omitted.

Because the collapsible transport vehicle 1 is comprised only of components that are attached to one another via joints, and the cross-strut 6 can be connected to the wheel suspensions 4 via a simple catch mechanism, simple set-up and disassembly of the transport vehicle 1 can be accomplished without additional tools.

The handle 10 is designed such that it may be used in conjunction with a towing unit fastened to a towing vehicle, such as a bicycle, allowing the transport vehicle 1 to be attached as a towed unit. Furthermore—not shown in the exemplary embodiment presented here—a mounting assembly for attaching a child safety seat may be provided on the load-receiving platform 2.

The exemplary embodiment shown here serves only to illustrate the invention and is not intended to limit its scope. In particular, the figures are schematic representations and are not drawn to scale with precise details.
1 Transport vehicle
2 Load-receiving platform
3 Hinged joint
4 Wheel suspension
5 Running Wheel
6 Cross-strut
7 Joint
8 Bar
9 Drawbar
10 Handle
11 Joint
12 Joint
13 Joints
14 Support strut
15 Joint
16 Joint
17 Joint
18 Boundary panel
19 Shaft
20 Support
21 Cam
22 Brake pad
23 Shaft
24 Universal joint
25 Carrying handle
26 Hanging brackets
27 Pin
28 Joint
29 Rocker

1. Collapsible transport vehicle, the vehicle comprising:
a load-receiving platform; and
at least one pair of running wheels, wherein the running wheels can be arranged on wheel suspensions that are pivotably attached on one side to the load-receiving platform, and in that the load-receiving platform comprises at least one joint, via which it can be collapsed.

2. The transport vehicle pursuant to claim 1, wherein the running wheels are rotatably fastened to the wheel suspensions.

3. The transport vehicle pursuant to claim 1, wherein when it is set up the wheel suspensions of the at least one pair of running wheels are positioned opposite one another and are stabilized against one another via a cross-strut that extends between the wheel suspensions.

4. The transport vehicle pursuant to claim 3, wherein the cross-strut is pivotably connected to the load-receiving platform (2) on its side that, when the platform is unfolded, faces the wheel suspensions, such that the cross strut can be shifted from a position of rest, in which it extends essentially parallel to the wheel suspensions, to an operational position, in which the wheel suspensions are supported and connected to one another, supporting one another.

5. The transport vehicle pursuant to claim 4, further comprising catch mechanisms arranged on the wheel suspensions, and operating in conjunction with ends of the cross-strut to lock the cross-strut with the wheel suspensions in an operating position.

6. The transport vehicle pursuant to claim 4, when the load-receiving platform is folded out it is provided on its side that faces the wheel suspensions with a bar extending parallel to and between the wheel suspensions, to which the cross-strut is pivotably fastened.

7. The transport vehicle pursuant to claim 1, further comprising support struts that are pivotably connected to the wheel suspensions on one side and to the load-receiving platform on the other side, and that extend diagonally when the transport vehicle is set up, wherein each support strut (14) is equipped with a joint between a point of connection with the load-receiving platform and a point of connection with the wheel suspension, so that when the wheel suspensions are pivoted from an operating position to a position of rest, the support struts can be collapsed.

8. The transport vehicle pursuant to claim 7, wherein the support struts are prestressed by at least one tension spring designed as a return spring.

9. The transport vehicle pursuant to claim 7, wherein the support struts can be actuated by a control cable, hydraulically or pneumatically.

10. The transport vehicle pursuant to claim 1, further comprising a drawbar arranged on the load-receiving platform.

11. The transport vehicle pursuant to claim 10, wherein the drawbar is equipped with a connecting element for connecting it to a towing device.

12. The transport vehicle pursuant to claim 10, wherein the drawbar is pivotably attached to the load-receiving platform.

13. The transport vehicle pursuant ding to claim 10, further comprising a securing device for fastening the drawbar in an operating position.

14. The transport vehicle pursuant to claim 13, further comprising openings in the drawbar and in the load-receiving platform, and by a locking pin that can be inserted into the openings to fasten the drawbar in its operating position.

15. The transport vehicle pursuant to claim 10, further comprising a handle arranged on the drawbar.

16. The transport vehicle pursuant to claim 15, wherein a fastening device that can be actuated via a handle.

17. The transport vehicle pursuant to claim 15, further comprising a shaft that extends along the drawbar and id connected to the handle, wherein said shaft operates by an arrangement comprised of:
at least one gear and possibly additional shafts in conjunction with two shafts that are equipped with cams;
wherein when the transport vehicle is set up, are arranged above the running wheels, such that when the shaft that extends along the drawbar is rotated, the cams of the two shafts act upon brake pads which when the transport vehicle is set up are located above the running wheels, wherein said brake pads then prevent the running wheels from turning.

18. The transport vehicle pursuant to claim 17, further comprising supports are arranged on the two shafts that are provided with cams, wherein, when these shafts are rotated into the position in which the cams act upon the brake pads, said supports unfold to support the transport vehicle, while when the two shafts are in their normal position in which the cams are not acting on the brake pads, these supports rest folded up under the load-receiving platform.

19. The transport device pursuant to claim 16, the fastening device further comprising a brake pads, brake pads, brake shoes and the like, which are actuable by a control cable.

20. The transport device pursuant to claim 19, the fastening device further comprises an actuating mechanism positioned on the handle of the drawbar.

21. The transport vehicle pursuant to claim 19, further comprising supports that can be moved from their folded-in position to a folded-out position by a control cable hydraulically, pneumatically or via some similar method.

22. The transport vehicle pursuant to claim 10, the drawbar is provided with at least one joint.

23. The transport vehicle pursuant to claim 1, the load-receiving platform is equipped along its edges with boundary panels, which can be folded down, on its side opposite the wheel suspensions.

24. The transport vehicle pursuant to claim 10, wherein the vehicle is collapsed to the size of a suitcase by pivoting the wheel suspensions, folding together the load-receiving platform, and folding down the drawbar.

25. The transport vehicle pursuant to claim 1, further comprising a carrying handle that is positioned on an element of the transport vehicle and that can be used when the transport vehicle is in a collapsed form.

26. The transport vehicle pursuant to claim 1, further comprising a fastening element arranged on the transport vehicle for the purpose of fastening a collapsed transport vehicle to a bicycle rack.

27. The transport vehicle pursuant to claim 1, further comprising a mounting assembly arranged on the load-receiving platform designed for mounting a child safety seat.

28. The transport vehicle pursuant to claim 1, the load receiving platform, the wheel suspensions, the drawbar and the struts are made of a lightweight metal.
